(19) United States
(12) Patent Application Publication
(10) Pub. No.: US 2007/0109476 A1
(43) Pub. Date: May 17, 2007

(54) Color cholesteric liquid crystal display device and manufacturing method for the same

(75) Inventors: Chi-Chang Liao, Tai Nan City (TW); Lung-Pin Hsin, Tai Chung City (TW); Yi-An Sha, Taipei City (TW)

Correspondence Address: RABIN & Berdo, PC, 1101 14TH STREET, NW, SUITE 500, WASHINGTON, DC, 20005, US

(73) Assignee: INDUSTRIAL TECHNOLOGY RESEARCH INSTITUTE

(21) Appl. No.: 11/484,733

(22) Filed: Jul. 12, 2006

(30) Foreign Application Priority Data
Nov. 15, 2005 (TW) 94140146

(51) Int. Cl. G02F 1/1335

(52) U.S. Cl. 349/115

(57) ABSTRACT

A cholesteric liquid crystal display device and a manufacturing method for the same are proposed. A micro-capsule uses a coating process to manufacture a color cholesteric liquid crystal display device. The present invention coats cholesteric liquid crystal having tunable chiral on a substrate with an electrode layer.

### BACKGROUND OF THE INVENTION

1. Field of the Invention

The present invention is related to a color cholesteric liquid crystal display device and a manufacturing method for the same, and more particularly to a color cholesteric liquid crystals having a tunable chiral that is coated on a bottom substrate with an electrode layer. The display is made of a cholesteric liquid crystal material via a micro-capsule and a coating process.

2. Description of Related Art

In recent years, polymer dispersed liquid crystal has been used in the form of droplets with a diameter of about 1 to 10 microns. From the application point of the view, PDLCs have unique optical properties: opaque in a field-OFF condition and transparent in a field-ON condition. They do not require polarizes and have very high transmittance in the ON-state. PDLCs may be used for switchable windows, direct-viewing displays and projection displays.

Starting from a uniform mixture of liquid crystal and polymer, phase separation can be induced via temperature change (Temperature Induced Phase Separation or TIPS), solvent evaporation (Solvent Induced Phase Separation or SIPS), and polymerization of the polymer precursor in the mixture (Polymerization Induced Phase Separation or PIPS). The size of the droplets can be controlled by the phase separation conditions.

U.S. Pat. No. 6,203,723B1 discloses a micro-capsule comprising liquid crystal material encapsulated in 1) polyurethanelpolyurea or polyurea polymer wall and 2) melamine-formaldehyde or a urea-formaldehyde polymer wall. The liquid crystal material is aligned in a polydomain configuration via a polymerization process. The liquid crystal that is to be microencapsulated, may be either nematic, cholesteric, smetic A, or ferroelectric. Reference is made to FIG. 1, which is an illustration of a polydomain configuration of a liquid crystal director induced by a polymer network in a liquid crystal capsule of the prior art. The discrete liquid crystal microcapsules 10 consist of the liquid crystal droplets 100 microcapsulated by the capsule wall 102. The polydomain configuration of liquid crystal director is induced by a polymer network (web-like structure) in a liquid crystal capsule. The polymer network 104 is performed via polymerization.

U.S. Pat. No. 6,061,107, “Bistable polymer dispersed cholesteric liquid crystal displays” uses a cholesteric liquid crystal having a color display effect. The cholesteric liquid crystals are confined in droplets or a domain. The size of the droplets or domain is controlled by the cell thickness and the process condition. The cholesteric liquid crystals focus on a plane spiral structure or a vertical spiral structure. At a zero field condition, the plane spiral structure or the vertical spiral structure are stable. The cell appears color reflective when the cholesteric liquid crystal has the plane spiral structure. The cell appears black (such as the black substrate appears to be coated with a black material) when the cholesteric liquid crystal has the vertical spiral structure. Between the liquid crystals are solid polymer walls.

A multicolor display prepared by the use of a photo tunable chiral material which is added to the cholesteric liquid crystal mixture. Different pitch lengths are achieved by irradiation with different levels of UV light.

### SUMMARY OF THE INVENTION

An object of the present invention is to form an UV-curable coating on a substrate having an electrode via a coating process. The UV curable coating is made of a mixture of cholesteric liquid crystal material, tunable chiral material and UV-curable resin. The present invention uses masking and ultraviolet light exposure processes to provide a color cholesteric liquid crystal display device.

For reaching the object above, the present invention provides a method for manufacturing a color cholesteric liquid crystal display device. It includes: providing a bottom substrate; making an electrode layer on the bottom substrate; forming a UV curable coating on the electrode layer; executing a curing process on the UV curable coating; and forming a color cholesteric liquid crystal display device.

The present invention provides a color cholesteric liquid crystal display device. It includes a bottom substrate; an electrode layer formed on the bottom substrate; UV curable coating on the electrode layer; and an exposed area formed on the UV curable coating, the exposed area concentrates a plurality of exposed sub-areas that give a plurality of exposure relative for forming the color cholesteric liquid crystal display.

The manufacturing method of the present invention uses the simple coat process to provide the color cholesteric liquid crystal display having a micro-capsule cholesteric liquid crystal feature on the substrate having electrodes.

Numerous additional features, benefits and details of the present invention are described in the detailed description, which follows.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is an illustration of a multi-domain configuration of liquid crystal director induced by a polymer network in a liquid crystal capsule of the prior art;

FIG. 2A is a schematic diagram of a flexible substrate of the present invention;

FIG. 2B shows a schematic diagram of an electrode layer manufacturing of the present invention;

FIG. 2C shows a schematic diagram of UV curable coating of the present invention;

FIG. 2D shows a schematic diagram of an exposure process of the present invention;

FIG. 2E shows a schematic diagram of a color cholesteric liquid crystal display device in accordance with the first embodiment of the present invention; and

FIG. 3 shows a schematic diagram of a color cholesteric liquid crystal display device of the present invention.

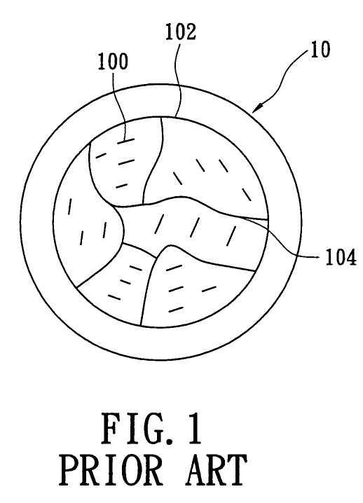

### DETAILED DESCRIPTION OF PREFERRED EMBODIMENTS

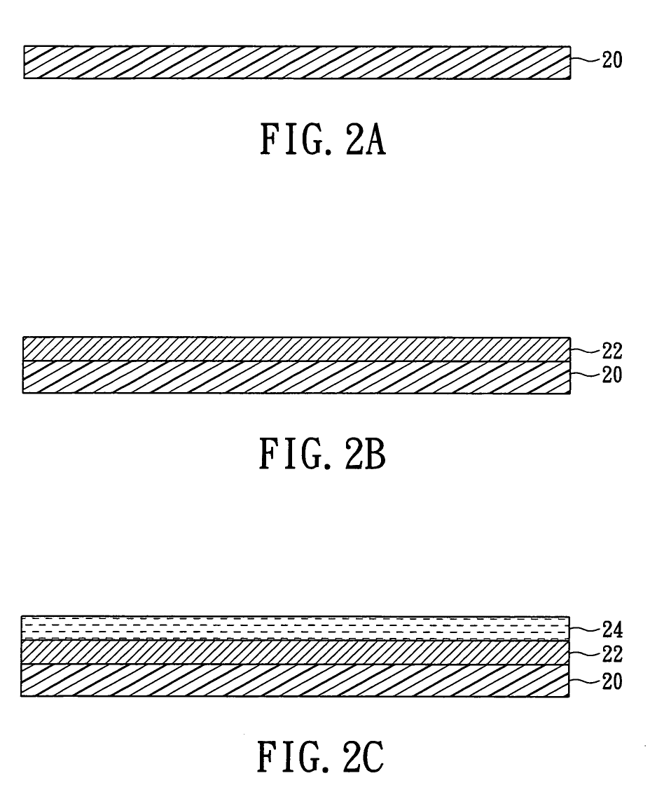

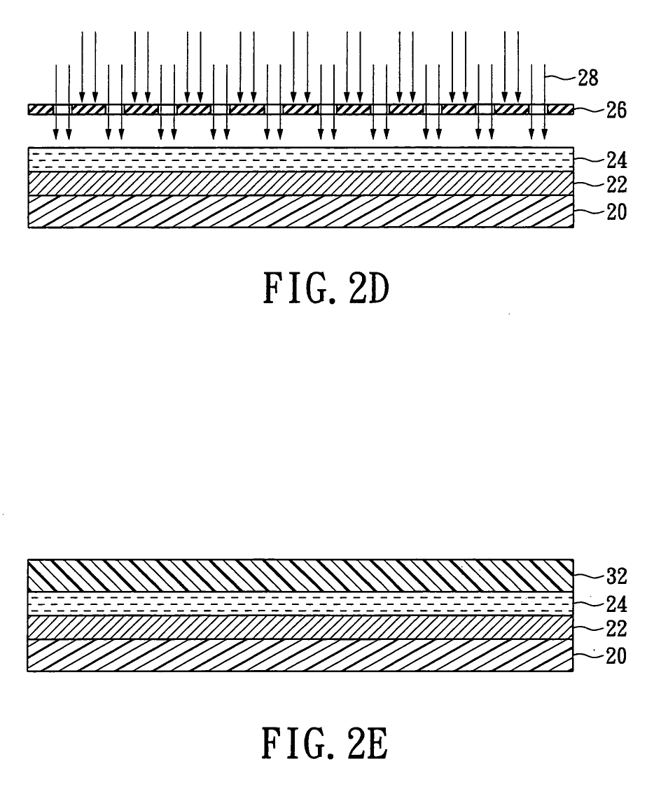

Reference is made to FIGS. 2A-D, which shows a schematic diagram of a color cholesteric liquid crystal display device manufactured in accordance with the present invention. In FIG. 2A, a bottom substrate 20 is shown. The bottom substrate 20 is made of a plastic substrate. In FIG. 2B, an electrode layer 22 is formed on the bottom substrate 20. The electrode layer 22 can be made of an inorganic conductive material or an organic conductive material. In FIG. 2C, a UV curable coating 24 is formed on the electrode layer 22 via a roll-to-roll process. The UV curable coating 24 is comprised of a mixture of liquid crystal material (such as nematic liquid crystals), a different ratio of a twist agent material, a tunable chiral material and UV-curable resin

In FIG. 2D, a curing process utilizes a mask 26 and an ultraviolet light 28 on the UV curable coating 24. The ultraviolet light 28 has a wavelength of 200-400 nm. A single layer of color micro-capsule cholesteric liquid crystal display device is formed by controlling the ultraviolet light 28 exposure. For example, if a defined area of the micro-capsule cholesteric liquid crystal layer 24 is red, than the mask 26 having high transmittance is used on the defined area of UV curable coating. If the defined area of the micro-capsule cholesteric liquid crystal layer 24 is green, than the mask 26 having medium transmittance is used on the defined area of UV curable coating. If the defined area of the micro-capsule cholesteric liquid crystal layer 24 is blue, than the mask 26 having low transmittance is used on the defined area of UV curable coating. A cholesteric liquid crystal layer display device is made after curing process.

Reference is made to FIG. 2E, which shows a schematic diagram of a color cholesteric liquid crystal display device manufactured in accordance with a second embodiment of the present invention. In this embodiment, an upper substrate 32 having an electrode layer covered over the micro-capsule cholesteric liquid crystal layer 24 via a coating process to make the cholesteric liquid crystal display device. Alternatively, an electrode layer is formed on the micro-capsule cholesteric liquid crystal layer 24 via a coating process firstly. Next, the upper substrate 32 is covered over the electrode layer to make the cholesteric liquid crystal display device. The electrode layer can be made of an inorganic conductive material or an organic conductive material.

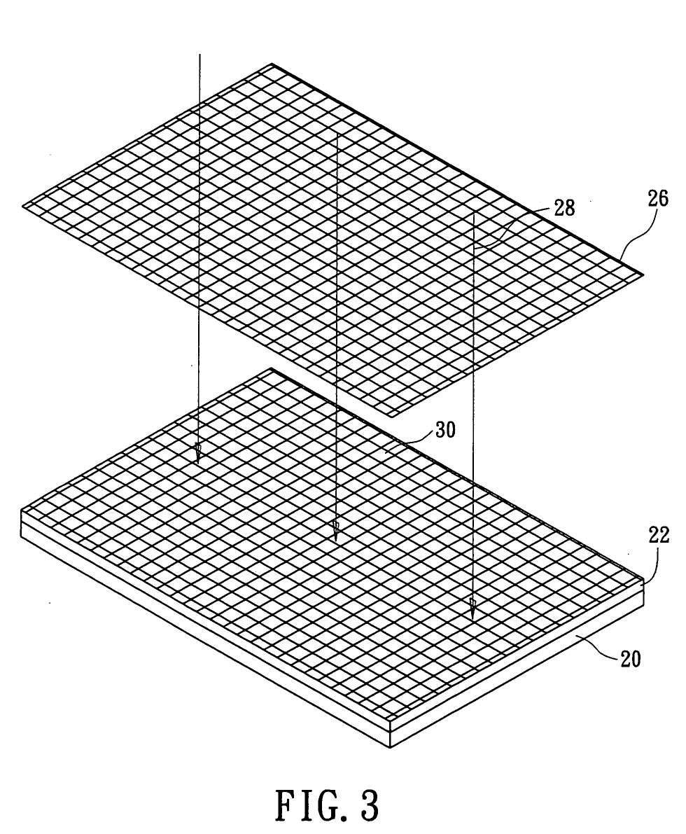

Reference is made to FIG. 3, which shows a schematic diagram of a color cholesteric liquid crystal display device in accordance with the present invention. The color cholesteric liquid crystal display device includes a bottom substrate 20. The bottom substrate 20 is a plastic substrate. An electrode layer 22 is made on the bottom substrate 20. The electrode layer 22 can be made of an inorganic conductive material or an organic conductive material. UV curable coating is formed on the electrode layer 22 via a roll-to-roll process. The UV curable coating is made of a mixture of liquid crystal material (such as nematic liquid crystals), a different ratio of a twist agent material, a tunable chiral material and UV-curable resin. In the second embodiment, the micro-capsule cholesteric liquid crystal layer covers the flexible upper having an electrode layer. Alternatively, an electrode layer is formed on the UV curable coating via a coating process to form a cholesteric liquid crystal display device. The electrode layer is formed via a coating process. A plurality of different exposed areas 30 are defined on the UV curable coating. Cure processes concentrate a plurality of exposed sub-areas via a mask 26 and ultraviolet light 28 to give a plurality of exposure amounts relative for achieving the color cholesteric liquid crystal display. The ultraviolet light 28 has a wavelength of 200-400 nm.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are embraced within the scope of the invention as defined in the appended claims.

What is claimed is:

1. A method for manufacturing a color cholesteric liquid crystal display device, comprising:
providing a bottom substrate;
making an electrode layer on the bottom substrate;
forming UV curable coating on the electrode layer executing a curing process on the UV curable coating; and
performing a color cholesteric liquid crystal display device.

2. The method as claimed in claim 1, wherein the bottom substrate is made of plastic.

3. The method as claimed in claim 1, wherein the electrode layer is made of an inorganic conductivity material or an organic conductivity material.

4. The method as claimed in claim 1, wherein the UV curable coating is formed on the electrode layer via a coating process.

5. The method as claimed in claim 1, wherein the coating process is a roll-to-roll process.

6. The method as claimed in claim 1, wherein the UV curable coating is made of a mixture of cholesteric liquid crystal material, tunable chiral material and UV-curable resin.

7. The method as claimed in claim 1, wherein the curing process is photo-curing process.

8. The method as claimed in claim 6, wherein the cholesteric liquid crystals are mixtures of nematic liquid crystal material and twist agents.

9. The method as claimed in claim 6, wherein the UV-curable resin is mixtures of UV-curable monomer, oligomer and photo-initiator.

10. The method as claimed in claim 1, wherein ultraviolet light and a mask are used for executing a curing process.

11. The method as claimed in claim 9, wherein the ultraviolet light has a wavelength of 200˜400 nm.

12. The method as claimed in claim 1, further comprises providing an upper substrate having an electrode layer on the micro-capsule cholesteric liquid crystals.

13. The method as claimed in claim 11, wherein the electrode layer is made of an inorganic conductivity material or an organic conductivity material.

14. The method as claimed in claim 1, further comprising forming an electrode layer on the micro-capsule cholesteric liquid crystals.

15. The method as claimed in claim 13, wherein the electrode layer is made of an inorganic conductivity material or an organic conductivity material.

16. The method as claimed in claim 13, wherein the electrode layer is formed via a costing process.

17. A color cholesteric liquid crystal display device, comprising:
a bottom substrate;
an electrode layer made on the bottom substrate;
a UV curable coating executed by a curing process formed on the electrode layer; and
an exposed area formed on t UV curable coating, the exposed area concentrates a plurality of exposed sub-areas to give a plurality of exposure amounts relative for achieving the color cholesteric liquid crystal display.

18. The method as claimed in claim 17, wherein the bottom substrate is made of plastic.

19. The method as claimed in claim 17, wherein the electrode layer is made of an inorganic conductivity material or an organic conductivity material.

20. The method as claimed in claim 17, wherein the UV curable coating is made of a mixture of cholesteric liquid crystal material,tunable chiral material and UV-curable resin.

21. The method as claimed in claim 17, wherein the curing process is photo-curing process.

22. The method as claimed in claim 17, wherein the UV curable coating is formed on the electrode layer via a coating process.

23. The method as claimed in claim 20, wherein the UV-curable resin is mixtures of UV-curable monomer, oligomer and photo-initiator.

24. The method as claimed in claim 17, wherein invisibility light and a mask are used for executing a curing process.

25. The method as claimed in claim 24, wherein the invisibility light has a wavelength of 200˜400 nm.

26. The method as claimed in claim 16, further comprising an upper substrate having an electrode layer.

27. The method as claimed in claim 16, wherein the electrode layer is made of an inorganic conductivity material or an organic conductivity material.

28. The method as claimed in claim 16, further comprising an electrode layer formed on the micro-capsule cholesteric liquid crystal layer.

29. The method as claimed in claim 26, wherein the electrode layer is made of an inorganic conductivity material or an organic conductivity material.

30. The method as claimed in claim 26, wherein the electrode layer is formed via a coating process.
